(19) United States
(12) Patent Application Publication
(10) Pub. No.: US 2013/0166636 A1
(43) Pub. Date: Jun. 27, 2013

(54) PORTABLE TERMINAL FOR A MOBILE NETWORK

(71) Applicant: Myriad France, Le Bourget-Du-Lac (FR)

(72) Inventors: Gaël Rosset, Chindrieux (FR); Sébastien Prugnard, Maisons Lafitte (FR)

(73) Assignee: Myriad France, Le Bourget-Du-Lac (FR)

(21) Appl. No.: 13/772,227

(22) Filed: Feb. 20, 2013

Related U.S. Application Data
(63) Continuation of application No. PCT/FR2011/051934, filed on Aug. 18, 2011.

(30) Foreign Application Priority Data
Aug. 20, 2010 (FR) 10 56692

(51) Int. Cl. H04L 29/08

(52) U.S. Cl. CPC H04L 67/02
USPC 709/203

(57) ABSTRACT

This terminal includes: means for wireless communications with the network; and a MMI for inputting information from the user and making available information for the user; and a browser capable of accessing the Internet network and including means for requesting a Web page on the network, direct access means for accessing a server having an original page available and means for receiving and making available the original page.

The browser includes assisted access means for accessing an assisted browsing server capable of providing a reformatted page and means for receiving and making available the reformatted page.

The terminal includes means for selectively applying the direct access means or the assisted access means depending on selection criteria.

### INCORPORATION BY REFERENCE TO RELATED APPLICATIONS

Any and all priority claims identified in the Application Data Sheet, or any correction thereto, are hereby incorporated by reference under 37 CFR 1.57.

### BACKGROUND

1. Field of the Invention

The present invention relates to a portable terminal for mobile networks of the type including:
means for wireless communications with the network;
a man-machine interface for inputting information from the user and making information available to the user;
a browser capable of accessing the Internet network, said browser includes:
   means for requesting a Web page on the network;
   direct access means for accessing a Web page server having a required original page on the Internet network;
   means for receiving and making available the required original page.

2. Description of the Related Technology

Portable terminals for mobile networks, and notably mobile telephones, include browsers giving the possibility of accessing Web pages available on servers of the Internet network. The Web pages are transmitted by the data network of the wireless telecommunications network to the portable terminal.

In the following of the description, an original Web page designates a non-reformatted Web page as it appears on a primary server making it available on the network.

The browsers of portable terminals are capable, like browsers available on fixed computers connected to the Internet network, of directly accessing the primary server having the required original Web page. This access mode is a consumer of traffic on the network since each required page is requested at the primary server having it.

Provision on the wired network of proxy cache servers is known, allowing original Web pages frequently requested by the mobile terminals of the network, to be stored temporarily. Thus, a page may be easily provided to several terminals making the same request without it being necessary to request every time this page at the primary server having the original Web page.

In both cases, the browser ensures direct access to the required original page in the sense that it obtains the required page in its original form either from the original server or from the proxy server.

In order to facilitate reading of the Web pages on mobile terminals, notably because of the narrowness of the viewing screen and of the low computation capabilities of the terminal, it is known how to fit out mobile terminals with browsers with which they may not access a server having the required original Web page but an assisted browsing server, which server is capable of requesting itself the required original Web page on the network and of ensuring re-formatting of this page so as to provide the terminal with a re-formatted Web page so as to facilitate its processing by the portable terminal and/or making it available to the user.

In this case, the browser installed on the terminal is known as a <<thin client>> browser. This browser has a reduced number of functions as compared with a browser providing direct access to the original Web pages.

The use of such a thin browser resorting to an assisted browsing server is known under the name of <<server-assisted browsing>>.

Portable terminals are equipped with either one of the types of browsers, thereby giving the possibility of either having original Web pages under sometimes different interpretation and processing conditions or easily having reformatted Web pages, some contents of which may be altered.

The object of the invention is to allow easy coordination of the access to the original Web pages, while benefiting from simple processing and fast availability of the contents of these pages.

For this purpose, the object of the invention is a portable terminal as defined above characterized in that the browser further includes assisted access means for accessing an assisted browsing server capable of providing a required page re-formatted by the assisted browsing server and means for receiving and making available the re-formatted required page and in that the portable terminal includes means for selectively applying the direct access means or the assisted access means according to selection criteria.

### SUMMARY OF CERTAIN ASPECTS OF THE INVENTION

According to particular embodiments, the portable terminal includes one or more of the following features:
the direct access means and the access means assisted by a server are integrated into the same browser.
the direct access means include means for selectively accessing a primary server or a proxy cache server and a means for selectively applying means for accessing the primary server or proxy cache server.
the means for selectively applying the direct access means or the assisted access means include means for receiving control commands from the Internet network and received through wireless communications means.
the means for selectively applying the direct access means or the assisted access means include means for receiving and taking into account a selection table indicating the access means which have to be applied according to characteristics of the wireless communications and/or of the visited sites.
the means for selectively applying the direct access means or the assisted access means include means for receiving control commands from the man-machine interface of the mobile terminal.
the means for selectively applying the direct access means or the assisted access means include means for configuring the same means for receiving and making available the required page for forming either the means for receiving and making available the original required page or the means for receiving and making available the re-formatted required page.

The object of the invention is also a wireless telecommunications network including at least one Web page server having original pages available, at least one assisted browsing server capable of providing a required page re-formatted by the assisted browsing server, at least one portable terminal compliant with the terminal shown above, and a server capable of sending to the mobile terminal selection criteria for applying the direct access means or the assisted access means.

### BRIEF DESCRIPTION OF THE DRAWINGS

The invention will be better understood upon reading the description which follows, only given as an example and made with reference to the drawing, the single figure of which is a schematic view of a wireless network having a portable telephone according to the invention.

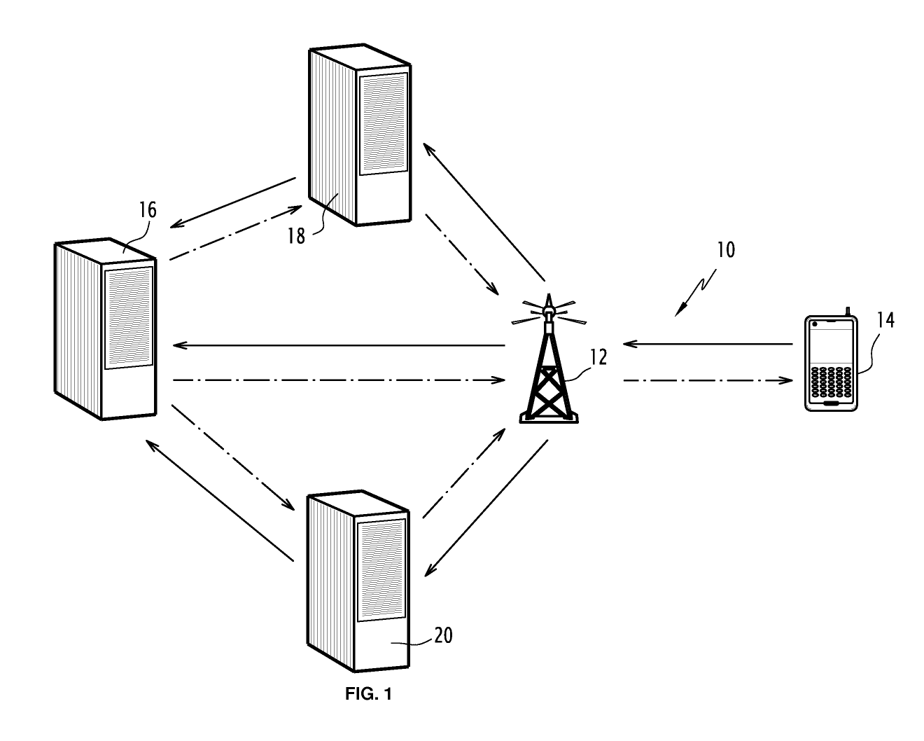

In FIG. 1, a mobile telecommunications network 10 is schematically illustrated, a base station 12 of which is illustrated capable of ensuring wireless communication with a portable terminal 14.

### DETAILED DESCRIPTION OF CERTAIN INVENTIVE EMBODIMENTS

This terminal 14 as known per se, includes means for wireless transmission of information from and towards the base station 12. It includes a man-machine interface with which information may be inputted and information made available. This for example is a keyboard and a screen.

Moreover, the terminal further includes a browser allowing access to the Internet network via the wireless network. The browser is set up as an application software package on the mobile terminal. It includes means for requesting a Web page on the network, means for accessing this Web page and means for receiving and making the required page available to the user of the terminal.

As known per se, the Internet network includes a set of primary servers having original Web pages available, one of which, designated by reference 16, is illustrated in the single figure.

This server 16 is in a relationship with the mobile telephone network schematized by the base station 12.

Moreover, the network includes proxy cache servers 18. The servers are connected through the network to the original Web page primary servers as well as to the mobile network via the base station 12.

These servers are of the HTTP proxy server type, i.e. able to be used to as an interface of mediation between two communicating computers, without changing the communications protocol.

These servers 18 are preferably provided with a cache function. To do this, they include a bulk memory capable of storing and regularly updating the original Web pages which are the most frequently consulted by the users of mobile terminals 14, thereby shortening the time for accessing these off-line consultable pages and reducing traffic on the network.

Finally, the network includes assisted browsing servers 20 connected through the network to the primary servers 16 and to the terminals 14 via the base stations 12.

These assisted browsing servers 20 are capable of ensuring the functions of a proxy cache server and of ensuring navigation assisted by a server for adapted thin client browsers, set up on the portable terminals 14.

Thus, the assisted browsing servers 20 are capable of ensuring adaptation of the contents, i.e. reformatting of the original Web pages for facilitating the reading, the use and the processing thereof on a portable terminal, for example by re-ordering the contents of the page, simplification of the contents or suppression of JavaScript routines.

These servers 20 are also capable of ensuring acceleration of the access to the contents of the Web pages, by ensuring temporary saving of the frequently accessed pages and compression of the pages for their transfer.

The servers 20 as known per se, finally ensure optimization of the contents by transcoding images or films into smaller and more efficient formats for processing on a portable terminal.

The portable terminal 14 includes an Internet browser including means for requesting a Web page on the Internet network. These means are for example an interface for inputting a keyword, a site name or any other means able to formulate a query, the expected answer of which is a required Web page.

It also includes direct access means for accessing a primary 16 or proxy cache 18 server for obtaining original Web pages.

These means are capable of constructing and sending a request according to the HTTP protocol to a remote server of the network.

Finally, the browser includes means for receiving and making available the required page received from the server.

Further, this same browser includes assisted access means for accessing an assisted browsing server 20 on the network for receiving from the server a required page reformatted by the assisted browsing server.

Finally, the portable terminal 14 includes means for selectively applying the direct access means or the assisted access means depending on predetermined selection criteria thereby allowing operation of the browser in a normal mode or in an assisted mode, respectively.

These means are notably able to modify the parameterization of the browser in order to define a path towards a primary 16 or proxy cache 18 server or towards an assisted access server 20, so that the browser acquires an original Web page or a reformatted Web page.

The selective application means include means for modifying the parameterization of the browser in order to make the latter a thin client, thereby allowing reformatted pieces of information to be made available.

Finally, the means for selectively applying the direct access means or the server-assisted access means include means for receiving a control message and for switching from one operating mode to the other for the whole of the sites which may be accessed or only for certain sites, the direct access means or the assisted access means then being used depending on the relevant site.

Examples will be described subsequently in the description.

During the operation of the mobile terminal, both modes for accessing the Web pages with the browser are available, the normal mode in which the direct access means are used and the assisted mode in which the assisted access means are used. In the normal mode, the direct access means ensure communications towards the primary server 16 or towards a proxy cache server 18 according to whether the latter has been identified beforehand or not.

The normal mode is thus broken down into two sub-modes, a first mode in which the pages are requested from the primary server 16 and a second mode in which the pages are requested from the proxy cache server 18.

According to a first embodiment, switching allowing control of the selective application means for direct or assisted, access to the Web pages is carried out on the initiative of the user from the man-machine interface 14, which for example gives a choice in a scrolling menu from among one of the possible modes and sub-modes.

According to another embodiment alternative or cumulative to the previous one, the means for selectively applying direct access or assisted access are controlled by the operator managing the portable telephones, i.e. from a server of the operator not shown in the figure transmitting control messages to the mobile terminal 14. This message is transmitted to the terminal 14 by any suitable technology such as SMS, USSD, WAP push, http header or configuration protocol (such as <<OMA Client Provisioning>> or <<OMA Device Management>> for example).

The control message is of the following form (X; Y; Z) wherein X is the type of destination server for providing the required Web pages, Y are the pages for which this server should be used, and Z is the address of the server 16, 18, or 20 to be used.

X may assume the value

SA for assisted access,

DIRECT for direct access from a primary server

PROXY for direct access from a proxy cache server.

Thus, for example, the control message assumes one of the following forms.

“SA;ALL;saproxy.operator.com”: use of an assisted browsing server called

“saproxy.operator.com” for all the sites

“DIRECT;ALL”: use of a primary server 16 for any site

“PROXY;ALL”;normalproxy.operator.com“: use of a proxy cache server 18 called “normalproxy.operator.com” for any site.

The commands may be combined like in the following example:

“SA;ALL; saproxy.operator.com

DIRECT;EXCEPTION;www.mybank.com”: use of an assisted access server for any site except for the site “mybank.com” for which access is achieved through a primary server.

It is thus understood that either one of the servers may thus be used for a certain type of required Web pages.

The operator, from the server sending the command messages, may then control the use of the mobile terminal passband per mobile terminal, promoting the use of the assisted browsing servers 20, when the passband is more reduced.

According to a further alternative or cumulative embodiment, the switching means allowing selective application of the direct access means or of the assisted access means may be initiated by the network depending on the operating and traffic conditions of the network.

More particularly, the selective application means ensure application of either one of the direct access or assisted access means depending on the type of link used by the portable terminal 14 for its connection to the network, and/or depending on the accessed site types. Thus, the mobile terminal 14 includes a table indicating, for each type of connection used and for each type of sites, the server which the terminal 14 should access for obtaining a Web page. An example of such a table is given below.

| | | | Assisted |
|---|---|---|---|
| | Direct mode | Proxy cache | mode |
| | Case of | mode | Case |
| | server 16 | Case of server 18 | of server 20 |
| Wi-Fi | X | | |
| 2.5G or 3G - peak | | | X |
| period | | | |
| 2.5G or 3G - off-peak | | X | |
| period | | | |
| 2.5G or 3G or 1x - data | | | X |
| transfer restriction | | | |
| period | | | |
| Secured sites | X | | |

Thus, it is understood that if the mobile terminal 14 accesses the network through a wi-fi connection, the means for directly accessing a server, such as the server 16, will be applied. The same applies regardless of the mode for accessing the network if the Web pages are requested from secured sites. Apart from peak periods and if the connection is ensured by the 2.5 G or 3G cell network, the direct access means using the proxy cache server 18 will be applied. During peak periods or during periods during which data transfers are restricted, the mobile terminal 14 will apply the server-assisted access means by accessing the assisted browsing server 20.

In this embodiment, the table is transmitted from the network to the mobile terminal 14, every time an upgrade is required. For this purpose, the browser includes means for receiving a new table and for upgrading the table from the new received table, this dynamically.

1. A portable terminal for a mobile network, comprising:
means for wireless communications with the network;
a man-machine interface configured to input information from the user and make information available to the user;
a browser configured to access the Internet network, the browser comprising:
means for requesting a Web page on the network;
direct access means for accessing a server of Web pages having an original required page on the Internet network;
means for receiving and making the original required page available,
assisted access means for accessing an assisted browsing server configured to provide a required page reformatted by the assisted browsing server;
means for receiving and making available the reformatted required page; and
means for selectively applying the direct access means or the assisted access means depending on selection criteria.

2. The portable terminal of claim 1, wherein the direct access means and the server-assisted access means are integrated into the same browser.

3. The portable terminal of claim 1, wherein the direct access means include:
means for selectively accessing a primary server or a proxy cache server; and,
means for selectively applying means for accessing the primary server or the proxy cache server.

4. The portable terminal of claim 1, wherein the means for selectively applying the direct access means or the assisted axis means include means for receiving control commands from the Internet network and received through wireless communications means.

5. The portable terminal of claim 4, wherein the means for selectively applying the direct access means or the assisted axis means include means for receiving and taking into account a selection table indicating the access means which have to be applied according to the characteristics of the wireless communications and/or to the visited sites.

6. The portable terminal of claim 1, wherein the means for selectively applying the direct access means or the assisted axis means include means for receiving control commands from the man-machine interface of the mobile terminal.

7. The portable terminal of claim 1, wherein the means for selectively applying the direct access means or the assisted axis means include means for configuring the same means in order to receive and make the required page available in order to form either the means for receiving and making available the original required page, or the means for receiving and making available the reformatted required page.

8. A wireless telecommunications system, comprising:
at least the one server of Web pages having original pages available;
at least one assisted browsing server configured to provide a required page reformatted by the assisted browsing server;
at least one portable terminal; and
a server configured to send to the mobile portable terminal selection criteria for communicating with the server or the assisted browsing server.

9. A portable terminal for a mobile network, comprising:
a communications mechanism configured to communicate with the network;
a man-machine interface configured to receive input information from a user and make information available to the user;
a browser configured to access the Internet via the network, the browser being further configured to:
request a web page, via the Internet via the network, from a server storing an original required page, the browser being further configured to receive and display the original required page;
request the web page, via the Internet via the network, from an assisted browsing server configured to provide a reformatted version of the original required page, the browser being further configured to receive and display the reformatted version of the original required page; and
selectively request the web page via one of the primary or proxy server or the assisted browser server based on a selection criteria.

10. The portable terminal of claim 9, wherein the server is one of a primary server or a proxy cache server, and wherein the browser is further configured to selectively request the web page from the primary server or the proxy cache server.

11. The portable terminal of claim 9, wherein the selection criteria is based on at least one of: a control command from the network, a selection table based on characteristics of the wireless communications and/or to visited sites and control commands received from a man-machine interface.

12. A method of operating a portable terminal for a mobile network, comprising:
on a web browser of the portable terminal, forming a request for a web page on the Internet network;
selectively determining based on a selection criteria one of:
requesting the web page via the Internet via the network from a server storing an original required page and receiving and displaying the original required page; or
requesting the web page via the Internet via the network from an assisted browsing server configured to provide a reformatted version of the original required page.

13. The method of claim 12, wherein the server is one of a primary server or a proxy cache server, and the method further comprises selectively requesting the web page from the primary server or the proxy cache server.

14. The method of claim 12, wherein the selection criteria is based on at least one of: a control command from the network, a selection table based on characteristics of the wireless communications and/or to visited sites and control commands received from a man-machine interface.
